(19) United States
(12) Patent Application Publication
(10) Pub. No.: US 2016/0295881 A1
(43) Pub. Date: Oct. 13, 2016

(54) NUTRITIONAL FROZEN FOOD PRODUCT

(71) Applicant: Nom Nom LLC, Gainesville, FL (US)

(72) Inventor: Kennette Boykin Hayter, Gainesville, FL (US)

(21) Appl. No.: 15/096,079

(22) Filed: Apr. 11, 2016

Related U.S. Application Data
(60) Provisional application No. 62/145,733, filed on Apr. 10, 2015.

(51) Int. Cl. A23G 9/42; A23G 9/50; A23G 9/32; A23G 1/50; A23G 9/38; A23G 9/36

(52) U.S. Cl. CPC A23G 9/42; A23G 9/38; A23G 9/366; A23G 9/325; A23G 1/50; A23L 1/38; A23G 9/503; A23V 2002/00

(57) ABSTRACT

The subject disclosure pertains to nutritional frozen food products and related methods of making the same. The frozen food products comprise fruit; a protein powder mix with one or more vitamins and one or more minerals; one or more gums; and one or more sweeteners.

### CROSS REFERENCE TO RELATED APPLICATIONS

This application claims the benefit of U.S. Provisional Application No. 62/145,733, filed Apr. 10, 2015, the disclosure of which is hereby incorporated herein by reference in its entirety.

### BACKGROUND

A common concern with sick children and adults, particularly the elderly, is that they may lose appetite, resulting in malnutrition and dehydration. Further, the supplement and nutritional drinks on the market generally suffer from poor flavor, making them a poor solution for providing nourishment in many cases. As proper nutrition is oftentimes a vital component in overcoming their health issues, sick children and adults are oftentimes repeatedly hospitalized as a result of improper nourishment.

### BRIEF SUMMARY

To address the aforementioned issues with providing nourishment in sick children and adults, the present disclosure provides frozen food products in the form of popsicles. The popsicles are all-natural, with no additives, artificial flavorings or color, and are fortified with vitamins, minerals, and proteins. Furthermore, the popsicles overcome the issues with current supplement and nutritional drinks on the market since they have desirable flavors in several varieties, as further explained herein.

In one aspect, the present disclosure provides a nutritional frozen food product comprising fruit; a protein powder mix, wherein the protein powder mix comprises whey protein, one or more vitamins, and one or more minerals; one or more gums; and one or more sweeteners. The frozen food product can be in the form of a popsicle.

In some embodiments, the fruit is selected from the group consisting of strawberry, pineapple, banana, orange, tangerine, coconut, and combinations thereof. The fruit can be in pureed, crushed, or juice forms. In some embodiments, the coconut is coconut water and/or coconut milk.

In some embodiments, the sweetener is honey, such as, for example, clover honey.

In some embodiments, the frozen food product comprises cocoa powder.

In some embodiments, the frozen food product comprises peanut butter. The peanut butter may, alternatively, be in a powder form.

In some embodiments, the one or more vitamins of the protein powder mix comprise palmitate, cholecalciferol, dl-alpha-tocopheryl acetate, cyanocobalamin, riboflavin, pyridoxine HCL, ascorbic acid, phytonadione, and combinations thereof.

In some embodiments, the one or more minerals of the protein powder mix comprise potassium iodide, ferrous fumarate, manganese sulfate, zinc sulfate, and combinations thereof.

### DETAILED DISCLOSURE

To provide nourishment in sick children and adults, or alternatively, to provide a nutritious snack for any child or adult, the present disclosure provides frozen food products in the form of popsicles. The present disclosure is also directed to methods of making the frozen food products disclosed herein.

Several aspects of the disclosure are described below, with reference to examples for illustrative purposes only. It should be understood that numerous specific details, relationships, and methods are set forth to provide a full understanding of the disclosure. One having ordinary skill in the relevant art, however, will readily recognize that the invention can be practiced without one or more of the specific details or practiced with other methods, protocols, and ingredients. The present disclosure is not limited by the illustrated ordering of acts or events, as some acts may occur in different orders and/or concurrently with other acts or events. Furthermore, not all illustrated acts, steps, or events are required to implement a methodology in accordance with the present disclosure. Many of the techniques and procedures described, or referenced herein, are well understood and commonly employed using conventional methodology by those skilled in the art.

Unless otherwise defined, all terms of art, notations and other terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

In one aspect, the present disclosure provides nutritional frozen food products comprising fruit; a protein powder mix, wherein the protein powder mix comprises whey protein, one or more vitamins, and one or more minerals; one or more gums; and one or more sweeteners. In some embodiments, the frozen food product can be in the form of a popsicle. The frozen food products described herein are all-natural, with no additives, artificial flavorings or color, and are fortified with vitamins, minerals, and proteins.

In some embodiments, the fruit is selected from the group consisting of strawberry, pineapple, banana, orange, tangerine, coconut, and combinations thereof. In some embodiments, the amount of fruit utilized (per ⅛ gallon mixture) is about 1 ounce to about 11 ounces. In some embodiments, the amount of fruit utilized (per ⅛ gallon mixture) is about 1 ounce to about 10 ounces. In some embodiments, the amount of fruit utilized (per ⅛ gallon mixture) is about 1 ounce to about 9 ounces. In some embodiments, the amount of fruit utilized (per ⅛ gallon mixture) is about 1 ounce to about 8 ounces. In some embodiments, the amount of fruit utilized (per ⅛ gallon mixture) is about 1 ounce to about 7 ounces. In some embodiments, the amount of fruit utilized (per ⅛ gallon mixture) is about 1 ounce to about 6 ounces. In some embodiments, the amount of fruit utilized (per ⅛ gallon mixture) is about 1 ounce to about 5 ounces. In some embodiments, the amount of fruit utilized (per ⅛ gallon mixture) is about 1 ounce to about 4 ounces. In some embodiments, the amount of fruit utilized (per ⅛ gallon mixture) is about 1 ounce to about 3 ounces. In some embodiments, the amount of fruit utilized (per ⅛ gallon mixture) is about 1 ounce to about 2 ounces. In some embodiments, the amount of fruit utilized (per ⅛ gallon mixture) is about 2 ounces to about 11 ounces. In some embodiments, the amount of fruit utilized (per ⅛ gallon mixture) is about 2 ounces to about 10 ounces. In some embodiments, the amount of fruit utilized (per ⅛ gallon mixture) is about 2 ounces to about 9 ounces. In some embodiments, the amount of fruit utilized (per ⅛ gallon mixture) is about 2 ounces to about 8 ounces. In some embodiments, the amount of fruit utilized (per ⅛ gallon mixture) is about 2 ounces to about 7 ounces. In some embodiments, the amount of fruit utilized (per ⅛ gallon mixture) is about 2 ounces to about 6 ounces. In some embodiments, the amount of fruit utilized (per ⅛ gallon mixture) is about 2 ounces to about 5 ounces. In some embodiments, the amount of fruit utilized (per ⅛ gallon mixture) is about 2 ounces to about 4 ounces. In some embodiments, the amount of fruit utilized (per ⅛ gallon mixture) is about 2 ounces to about 3 ounces. In some embodiments, the amount of fruit utilized (per ⅛ gallon mixture) is about 3 ounces to about 11 ounces. In some embodiments, the amount of fruit utilized (per ⅛ gallon mixture) is about 3 ounces to about 10 ounces. In some embodiments, the amount of fruit utilized (per ⅛ gallon mixture) is about 3 ounces to about 9 ounces. In some embodiments, the amount of fruit utilized (per ⅛ gallon mixture) is about 3 ounces to about 8 ounces. In some embodiments, the amount of fruit utilized (per ⅛ gallon mixture) is about 3 ounces to about 7 ounces. In some embodiments, the amount of fruit utilized (per ⅛ gallon mixture) is about 3 ounces to about 6 ounces. In some embodiments, the amount of fruit utilized (per ⅛ gallon mixture) is about 3 ounces to about 5 ounces. In some embodiments, the amount of fruit utilized (per ⅛ gallon mixture) is about 3 ounces to about 4 ounces. In some embodiments, the amount of fruit utilized (per ⅛ gallon mixture) is about 4 ounces to about 11 ounces. In some embodiments, the amount of fruit utilized (per ⅛ gallon mixture) is about 4 ounces to about 10 ounces. In some embodiments, the amount of fruit utilized (per ⅛ gallon mixture) is about 4 ounces to about 9 ounces. In some embodiments, the amount of fruit utilized (per ⅛ gallon mixture) is about 4 ounces to about 8 ounces. In some embodiments, the amount of fruit utilized (per ⅛ gallon mixture) is about 4 ounces to about 7 ounces. In some embodiments, the amount of fruit utilized (per ⅛ gallon mixture) is about 4 ounces to about 6 ounces. In some embodiments, the amount of fruit utilized (per ⅛ gallon mixture) is about 4 ounces to about 5 ounces. In some embodiments, the amount of fruit utilized (per ⅛ gallon mixture) is about 5 ounces to about 11 ounces. In some embodiments, the amount of fruit utilized (per ⅛ gallon mixture) is about 5 ounces to about 10 ounces. In some embodiments, the amount of fruit utilized (per ⅛ gallon mixture) is about 5 ounces to about 9 ounces. In some embodiments, the amount of fruit utilized (per ⅛ gallon mixture) is about 5 ounces to about 8 ounces. In some embodiments, the amount of fruit utilized (per ⅛ gallon mixture) is about 5 ounces to about 7 ounces. In some embodiments, the amount of fruit utilized (per ⅛ gallon mixture) is about 5 ounces to about 6 ounces. In some embodiments, the amount of fruit utilized (per ⅛ gallon mixture) is about 6 ounces to about 11 ounces. In some embodiments, the amount of fruit utilized (per ⅛ gallon mixture) is about 6 ounces to about 10 ounces. In some embodiments, the amount of fruit utilized (per ⅛ gallon mixture) is about 6 ounces to about 9 ounces. In some embodiments, the amount of fruit utilized (per ⅛ gallon mixture) is about 6 ounces to about 8 ounces. In some embodiments, the amount of fruit utilized (per ⅛ gallon mixture) is about 6 ounces to about 7 ounces. In some embodiments, the amount of fruit utilized (per ⅛ gallon mixture) is about 7 ounces to about 11 ounces. In some embodiments, the amount of fruit utilized (per ⅛ gallon mixture) is about 7 ounces to about 10 ounces. In some embodiments, the amount of fruit utilized (per ⅛ gallon mixture) is about 7 ounces to about 9 ounces. In some embodiments, the amount of fruit utilized (per ⅛ gallon mixture) is about 7 ounces to about 8 ounces. In some embodiments, the amount of fruit utilized (per ⅛ gallon mixture) is about 8 ounces to about 11 ounces. In some embodiments, the amount of fruit utilized (per ⅛ gallon mixture) is about 8 ounces to about 10 ounces. In some embodiments, the amount of fruit utilized (per ⅛ gallon mixture) is about 8 ounces to about 9 ounces. In some embodiments, the amount of fruit utilized (per ⅛ gallon mixture) is about 9 ounces to about 11 ounces. In some embodiments, the amount of fruit utilized (per ⅛ gallon mixture) is about 9 ounces to about 10 ounces. In some embodiments, the amount of fruit utilized (per ⅛ gallon mixture) is about 1, 2, 3, 4, 5, 6, 7, 8, 9, 10, or 11 ounces. In some embodiments, the amount of fruit utilized (per ⅛ gallon mixture) is about 50 grams to about 250 grams. In some embodiments, the amount of fruit utilized (per ⅛ gallon mixture) is about 50 grams to about 200 grams. In some embodiments, the amount of fruit utilized (per ⅛ gallon mixture) is about 50 grams to about 150 grams. In some embodiments, the amount of fruit utilized (per ⅛ gallon mixture) is about 50 grams to about 100 grams. In some embodiments, the amount of fruit utilized (per ⅛ gallon mixture) is about 50 grams to about 75 grams. In some embodiments, the amount of fruit utilized (per ⅛ gallon mixture) is about 50 grams to about 70 grams. In some embodiments, the amount of fruit utilized (per ⅛ gallon mixture) is about 50 grams to about 65 grams. In some embodiments, the amount of fruit utilized (per ⅛ gallon mixture) is about 50 grams to about 60 grams. In some embodiments, the amount of fruit utilized (per ⅛ gallon mixture) is about 50 grams to about 55 grams. In some embodiments, the amount of fruit utilized (per ⅛ gallon mixture) is about 60 grams to about 65 grams. In some embodiments, the amount of fruit utilized (per ⅛ gallon mixture) is about 100 grams to about 110 grams. In some embodiments, the amount of fruit utilized (per ⅛ gallon mixture) is about 100 grams to about 105 grams. In some embodiments, the amount of fruit utilized (per ⅛ gallon mixture) is about 200 grams to about 250 grams. In some embodiments, the amount of fruit utilized (per ⅛ gallon mixture) is about 210 grams to about 250 grams. In some embodiments, the amount of fruit utilized (per ⅛ gallon mixture) is about 220 grams to about 250 grams. In some embodiments, the amount of fruit utilized (per ⅛ gallon mixture) is about 230 grams to about 250 grams. In some embodiments, the amount of fruit utilized (per ⅛ gallon mixture) is about 240 grams to about 250 grams. In some embodiments, the amount of fruit utilized (per ⅛ gallon mixture) is about 245 grams to about 250 grams. In some embodiments, the amount of fruit utilized (per ⅛ gallon mixture) is about 53, 63, 64, 105, or 245 grams.

The fruit can be in pureed, crushed, or juice forms. In some embodiments, the coconut is coconut water and/or coconut milk.

In some embodiments, the one or more gums comprise guar gums, locust bean gums, xanthan gums, carob bean gums, carrageenan, alginates, or combinations thereof. In a preferred embodiment, the gums utilized can include those sold under the trademark, Ticaloid®, which include Pre-Hydrated Ticaloid®1155 Non-GMO. Such Ticaloid® products generally comprise gun acacia, xanthan gum and guar gum. When Ticaloid® products are utilized, they are mixed at about 5 grams for every 0.75 gallons of premix, as further described herein.

In some embodiments, the sweetener is honey, such as, for example, clover honey, orange blossom honey, tupelo honey, gallberry honey, wildflower honey, sourwood honey, saw palmetto honey, or combinations thereof. In some embodiments, the amount of sweetener utilized (per ⅛ gallon mixture) is about 1 grams to about 3 grams. In some embodiments, the amount of sweetener utilized (per ⅛ gallon mixture) is about 1 grams to about 2 grams. In some embodiments, the amount of sweetener utilized (per ⅛ gallon mixture) is about 2 grams to about 3 grams. In some embodiments, the amount of sweetener utilized (per ⅛ gallon mixture) is about 2 grams. In some embodiments, the amount of sweetener utilized (per ⅛ gallon mixture) is about 2.5 grams.

In some embodiments, the frozen food product comprises cocoa powder. The cocoa powder provides a chocolate flavor to the food product. In some embodiments, the amount of cocoa powder utilized (per ⅛ gallon mixture) is about 1 gram to about 4 grams. In some embodiments, the amount of cocoa powder utilized (per ⅛ gallon mixture) is about 1 gram to about 3 grams. In some embodiments, the amount of cocoa powder utilized (per ⅛ gallon mixture) is about 1 gram to about 2 grams. In some embodiments, the amount of cocoa powder utilized (per ⅛ gallon mixture) is about 2 grams to about 4 grams. In some embodiments, the amount of cocoa powder utilized (per ⅛ gallon mixture) is about 2 grams to about 3 grams. In some embodiments, the amount of cocoa powder utilized (per ⅛ gallon mixture) is about 3 gram to about 4 grams. In some embodiments, the amount of cocoa powder utilized (per ⅛ gallon mixture) is about 3 grams. In some embodiments, the frozen food product comprises peanut butter. The peanut butter may, alternatively, be in a powder form. In some embodiments, the amount of peanut butter or peanut butter powder utilized (per ⅛ gallon mixture) is about 20 grams to about 30 grams. In some embodiments, the amount of peanut butter or peanut butter powder utilized (per ⅛ gallon mixture) is about 20 grams to about 25 grams. In some embodiments, the amount of peanut butter or peanut butter powder utilized (per ⅛ gallon mixture) is about 20 grams to about 24 grams. In some embodiments, the amount of peanut butter or peanut butter powder utilized (per ⅛ gallon mixture) is about 20 grams to about 23 grams. In some embodiments, the amount of peanut butter or peanut butter powder utilized (per ⅛ gallon mixture) is about 20 grams to about 22 grams. In some embodiments, the amount of peanut butter or peanut butter powder utilized (per ⅛ gallon mixture) is about 20 grams to about 21 grams. In some embodiments, the amount of peanut butter or peanut butter powder utilized (per ⅛ gallon mixture) is about 21 grams to about 30 grams. In some embodiments, the amount of peanut butter or peanut butter powder utilized (per ⅛ gallon mixture) is about 21 grams to about 25 grams. In some embodiments, the amount of peanut butter or peanut butter powder utilized (per ⅛ gallon mixture) is about 21 grams to about 24 grams. In some embodiments, the amount of peanut butter or peanut butter powder utilized (per ⅛ gallon mixture) is about 21 grams to about 23 grams. In some embodiments, the amount of peanut butter or peanut butter powder utilized (per ⅛ gallon mixture) is about 21 grams to about 22 grams. In some embodiments, the amount of peanut butter or peanut butter powder utilized (per ⅛ gallon mixture) is about 22 grams to about 30 grams. In some embodiments, the amount of peanut butter or peanut butter powder utilized (per ⅛ gallon mixture) is about 22 grams to about 25 grams. In some embodiments, the amount of peanut butter or peanut butter powder utilized (per ⅛ gallon mixture) is about 22 grams to about 24 grams. In some embodiments, the amount of peanut butter or peanut butter powder utilized (per ⅛ gallon mixture) is about 22 grams to about 23 grams. In some embodiments, the amount of peanut butter or peanut butter powder utilized (per ⅛ gallon mixture) is about 23 grams to about 30 grams. In some embodiments, the amount of peanut butter or peanut butter powder utilized (per ⅛ gallon mixture) is about 23 grams to about 25 grams. In some embodiments, the amount of peanut butter or peanut butter powder utilized (per ⅛ gallon mixture) is about 23 grams to about 24 grams. In some embodiments, the amount of peanut butter or peanut butter powder utilized (per ⅛ gallon mixture) is about 22 grams. In some embodiments, the amount of peanut butter or peanut butter powder utilized (per ⅛ gallon mixture) is about 23 grams.

In some embodiments, the one or more vitamins of the protein powder mix comprise Vitamin A, Vitamin D3, Vitamin E, Vitamin B12, Vitamin B2, Vitamin B6, Vitamin C, Vitamin K1, and combinations thereof. The types of Vitamin A can include, for example, palmitate; the types of Vitamin D3 can include, for example, cholecalciferol; the types of Vitamin E can include, for example, dl-alpha-tocopheryl acetate; the types of Vitamin B 12 can include, for example, cyanocobalamin; the types of Vitamin B2 can include, for example, riboflavin; the types of Vitamin B6 can include, for example, pyridoxine HCL; the types of Vitamin C can include, for example, ascorbic acid; the types of Vitamin K1 can include, for example, phytonadione. The amounts of each of the vitamins described in the protein powder mix are shown in Table 1 as the minimum amount. As such, one skilled in the art will recognize, as is contemplated by the present disclosure, the vitamins may be included in amounts greater than the minimum amount disclosed.

In some embodiments, the one or more minerals of the protein powder mix comprise potassium iodide (as a source of iodine), ferrous fumarate (as a source of iron), manganese sulfate (as a source of manganese), zinc sulfate (as a source of zinc), and combinations thereof. The amounts of each of the minerals described in the protein powder mix are shown in Table 1 as the minimum amount. As such, one skilled in the art will recognize, as is contemplated by the present disclosure, the minerals may be included in amounts greater than the minimum amount disclosed.

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Materials and Methods

Each of the recipes described in the following examples are prepared as ⅛ gallon mixtures and then frozen bars of 3 fluid ounce serving sizes are produced. The powder premix utilized in the recipes is provided in Table 1.

TABLE 1
Composition of Premix. 2.82 grams of premix per 3 fluid
ounce serving size.

| | | | Percentage of |
|---|---|---|---|
| | | | Recommended |
| | | | Daily |
| Composition of Premix per 2.82 grams | Minimum | | Allowance |
| Vitamin A (as Palmitate, USP-FCC) | 500 | IU | 10 |
| Vitamin D3 (as Cholecalciferol, | 40 | IU | 10 |
| USP-FCC) | | | |
| Vitamin E (as dl-alpha-Tocopheryl | 3 | IU | 10 |
| Acetate, USP-FCC) | | | |
| Vitamin B12 (as Cyanocobalamin, USP) | 1.5 | mcg | 25 |
| Vitamin B2 (as Riboflavin, USP-FCC) | 0.17 | mg | 10 |
| Vitamin B6 (as Pyridoxine HCL, | 0.5 | mg | 25 |
| USP-FCC) | | | |
| Vitamin C (as Ascorbic Acid, USP-FCC) | 15 | mg | 25 |
| Vitamin K1 (as Phytonadione, USP) | 80 | mcg | 100 |
| Iodine (as Potassium Iodide, USP-FCC) | 22.5 | mcg | 15 |
| Iron (as Ferrous Fumarate, USP) | 1.8 | mg | 10 |
| Manganese (as Manganese Sulfate (1H20), | 0.2 | mg | 10 |
| USP-FCC) | | | |
| Zinc (as Zinc Sulfate, USP-FCC) | 1.5 | mg | 10 |
| Protein (as Whey Protein Isolate) | 2500 | mg | 5 |

The process for making the frozen bars (i.e., popsicles) is as follows:

1. The chilled fruit products, chilled water and any powders (premix) are blended in 240 gallon tanks.

2. The mix is pumped into a Vitaline® ice pop machine, which fills the molds 6 at a time from the hopper.

3. The molds index forward on the conveyor, which runs over a calcium chloride brine.

4. At about half way down the conveyor, the pops are semi frozen and the machine automatically inserts six sticks at a time, one per pop.

5. The move down the conveyor until completely frozen, the molds elevate are hit from underneath by a blast of fresh water and the pops are automatically extracted from the molds.

6. The machine indexes the pops forward onto a conveyor that introduces the pops into an automatic wrapper.

7. The pops are individually packaged and sent on a conveyor through a metal detector.

8. Finally, the pops are manually packed into 24 count cartons and put in a freezer.

It should be understood that in addition to the ingredients particularly mentioned above, the formulations may include other ingredients conventional in the art having regard to the type of formulation in question; for example, additional flavoring agents may be included in the formulations.

The following examples are illustrative of the practices of the disclosure, and not meant to be a limitation thereof.

### EXAMPLE 1

To produce a banana-strawberry flavored nutritional popsicle, 53 grams of strawberry puree, 63.6 grams of crushed pineapple, 105 grams of banana puree, 2.5 fluid ounces of clover honey, 3 grams of cocoa powder, 0.8375 grams of Ticaloid®, and 15.03 grams of premix are mixed together. The volume of the mixture is brought up to ⅛ of a gallon with water. Individual popsicles of 3 fluid ounces are produced by the methods described in the Materials and Methods.

### EXAMPLE 2

To produce a banana-peanut butter flavored nutritional popsicle, 245 grams of banana puree, 22.6 grams of peanut butter powder, 2 fluid ounces of clover honey, 3 grams of cocoa powder, 0.8375 grams of Ticaloid®, and 15.03 grams of premix are mixed together. The volume of the mixture is brought up to ⅛ of a gallon with water. Individual popsicles of 3 fluid ounces are produced by the methods described in the Materials and Methods.

### EXAMPLE 3

To produce a citrus flavored nutritional popsicle, 1 fluid ounce of orange juice concentrate, 7 fluid ounces of tangerine juice concentrate, 2 fluid ounces of clover honey, 3 fluid ounces of coconut water, 0.8375 grams of Ticaloid®, and 15.03 grams of premix are mixed together. The volume of the mixture is brought up to ⅛ of a gallon with water. Individual popsicles of 3 fluid ounces are produced by the methods described in the Materials and Methods.

### EXAMPLE 4

To produce a pineapple-coconut flavored nutritional popsicle, 2 fluid ounces of coconut milk, 2 fluid ounces of coconut water, 2 fluid ounces of clover honey, 2 fluid ounces of crushed pineapple, 1 fluid ounce of pineapple juice concentrate, 0.8375 grams of Ticaloid®, and 15.03 grams of premix are mixed together. The volume of the mixture is brought up to ⅛ of a gallon with water. Individual popsicles of 3 fluid ounces are produced by the methods described in the Materials and Methods.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

I claim:

1. A frozen food product, comprising:
a fruit;
a protein powder mix, wherein the protein powder mix comprises whey protein, one or more vitamins, and one or more minerals;
one or more gums; and
a sweetener.

2. The frozen food product of claim 1, wherein the fruit is selected from the group consisting of strawberry, pineapple, banana, orange, tangerine, coconut, and combinations thereof.

3. The frozen food product of claim 1, wherein the sweetener is honey.

4. The frozen food product of claim 3, wherein the honey is clover honey.

5. The frozen food product of claim 2, wherein one or more of the fruit is in a pureed form.

6. The frozen food product of claim 2, wherein one or more of the fruit is in a crushed form.

7. The frozen food product of claim 2, wherein one or more of the fruit is in a juice form.

8. The frozen food product of claim 2, wherein the coconut is coconut water.

9. The frozen food product of claim 2, wherein the coconut is coconut milk.

10. The frozen food product of claim 1, further comprising cocoa powder.

11. The frozen food product of claim 1, further comprising peanut butter.

12. The frozen food product of claim 11, wherein the peanut butter is in a powder form.

13. The frozen food product of claim 1, wherein the one or more vitamins of the protein powder mix comprise palmitate, cholecalciferol, dl-alpha-tocopheryl acetate, cyanocobalamin, riboflavin, pyridoxine HCL, ascorbic acid, phytonadione, and combinations thereof.

14. The frozen food product of claim 1, wherein the one or more minerals of the protein powder mix comprise potassium iodide, ferrous fumarate, manganese sulfate, zinc sulfate, and combinations thereof.

15. A frozen food product, comprising:
a fruit, wherein the fruit is selected from the group consisting of strawberry, pineapple, banana, orange, tangerine, coconut, and combinations thereof;
a protein powder mix, wherein the protein powder mix comprises whey protein, one or more vitamins, and one or more minerals;
one or more gum; and
a sweetener, wherein the sweetener is honey.
